(19) United States
(12) Patent Application Publication
(10) Pub. No.: US 2011/0222465 A1
(43) Pub. Date: Sep. 15, 2011

(54) COMMUNICATION TERMINAL, RELAY DEVICE, WIRELESS COMMUNICATION SYSTEM, WIRELESS COMMUNICATION CONTROL METHOD, AND PROGRAM

(76) Inventors: Nobuhiko Arashin, Osaka (JP); Osamu Tanaka, Osaka (JP); Toyoshi Yamada, Osaka (JP); Hiroyuki Yurugi, Osaka (JP); Masahiko Nagoshi, Osaka (JP); Akihiko Shiotsuki, Osaka (JP)

(21) Appl. No.: 13/130,415

(22) PCT Filed: Nov. 26, 2009
(86) PCT No.: PCT/JP2009/006380

§ 371 Date: May 20, 2011

(30) Foreign Application Priority Data
Nov. 26, 2008 (JP) 2008-301722

(51) Int. Cl. H04W 4/00

(52) U.S. Cl. 370/315

(57) ABSTRACT

A communication terminal is connected to a wireless communication system in which an access point and a communication destination device are connected, and performs wireless communication with the communication destination device. Specifically, the communication terminal includes: a connection communication availability inquiring unit (411) that transmits a direct communication availability inquiry to the wireless communication system via the access point, the direct communication availability inquiry being an inquiry about whether or not there is a function of performing direct wireless communication that is wireless communication not via the access point; and a connection state switching unit (413) that switches communication between the communication terminal and the communication destination device, from indirect wireless communication to the direct wireless communication, according to receipt of a direct communication availability notification from the communication destination device in response to the direct communication availability inquiry, the indirect wireless communication being wireless communication via the access point, and the direct communication availability notification indicating that the direct wireless communication is available.

### TECHNICAL FIELD

The present invention relates to information processing techniques, and particularly to an information processing technique that enables determining whether or not wireless communication with an external device by direct linking is available.

### BACKGROUND ART

Conventionally known services for establishing a radio communication path between terminals are a wireless direct link service that provides a direct wireless connection and a wireless indirect link service that provides an indirect wireless connection via a wireless access point (a base station). A wireless communication system is known which is capable of providing both the wireless direct link service and the wireless indirect link service.

Furthermore, as shown in FIG. 26, an information communication device is known which provides a technique in which, upon determining whether or not the wireless direct connection is available, it is not necessary to extend the processing at the base station and to have a communication destination terminal fixed in advance and in which a communication traffic load is small (refer to PTL 1).

### CITATION LIST

### Patent Literature

[Patent Literature 1]
Japanese Unexamined Patent Application Publication No. 2007-104600

### SUMMARY OF INVENTION

### Technical Problem

However, the above information communication device with a conventional structure is designed to include, as a precondition, wireless communication means that communicates with a wireless communication system, and is therefore effective only in the case where a media server, a media renderer, or the like incorporates the wireless communication means.

However, in general, not all the terminals (the terminating devices) connected to the wireless communication system necessarily incorporate the wireless communication means, and there is a case where a relay device such as an Ethernet® converter is applied instead. Thus, with the above conventional method, it is not possible in such a wireless communication system to timely implement direct link setup (DLS), for example, before a stream is reproduced. The wireless communication system ends up implementing DLS for all the devices supporting DLS.

In view of the above conventional problem, an object of the present invention is to provide a communication terminal, a relay device, a wireless communication system, a wireless communication control method, and a program for use in those stated, which enable timely implementation of DLS even in a wireless communication system with a device incorporating no wireless communication means.

### Solution to Problem

A communication terminal according to an aspect of the present invention is a communication terminal which is connected to a wireless communication system in which an access point and a communication destination device are connected, and performs wireless communication with the communication destination device, the access point relaying data in wireless communication, and the communication destination device being wirelessly connected to the access point. Specifically, the communication terminal includes: a direct communication availability inquiring unit configured to transmit a direct communication availability inquiry to the wireless communication system via the access point, the direct communication availability inquiry being an inquiry for searching for a device having a function of performing direct wireless communication that is wireless communication not via the access point; and a connection state switching unit configured to switch communication between the communication terminal and the communication destination device, from indirect wireless communication to the direct wireless communication, according to receipt of a direct communication availability notification from the communication destination device in response to the direct communication availability inquiry, the indirect wireless communication being wireless communication via the access point, and the direct communication availability notification indicating that the direct wireless communication is available.

Confirming that a communication destination supports direct wireless communication, before switching between the indirect wireless communication and the direct wireless communication, as in the configuration described above, will improve communication reliability.

Furthermore, the communication terminal is connected, via a wired network, to a first relay device that relays data between the communication terminal and the wireless communication system so that the communication terminal is connected indirectly to the wireless communication system. In addition, the connection state switching unit may be configured to transmit a direct communication start instruction to the first relay device according to receipt of the direct communication availability notification from both the communication destination device and the first relay device, the direct communication start instruction being an instruction to start the direction wireless communication between the communication destination device and the first relay device.

Furthermore, the communication destination device includes: a destination terminal that performs communication with the communication terminal; and a second relay device that is connected via a wired network to the destination terminal and relays data between the destination terminal and the wireless communication system. In addition, the connection state switching unit may be configured to transmit the direct communication start instruction to the first relay device according to receipt of the direct communication availability notification from both the first and second relay devices, the direct communication start instruction being an instruction to start the direct wireless communication between the first relay device and the second relay device.

With each of the configurations described above in which the communication terminal notifies the relay device of the timing for switching to the indirect wireless communication and of a communication destination with which the indirect wireless communication is to be established, the communication method can be timely switched even when one or both of the devices which establish the indirect wireless communication are the relay devices.

It is to be noted that “wired network communication” herein indicates wired connection (which is typically the Ethernet® connection) between independent devices which are connected to a network. For example, cables to be used only need to be commonly-used ones that can establish device-to-device communication, such as an Ethernet® cable, a universal serial bus (USB) cable, and an Institute of Electrical and Electronic Engineers (IEEE) 1394 cable. This should be, however, distinguished from the connection between PC and a wireless communication interface through a PCI bus or the like, for example.

Furthermore, the communication terminal includes a connection mode inquiring unit configured to transmit a connection mode inquiry to each of the first relay device and the second relay device, the connection mode inquiry being an inquiry about information on a terminal connected via a wired network to a corresponding one of the first and second relay devices. In addition, the connection state switching unit may be further configured to transmit the direction communication start instruction to the first relay device when it is determined, based on responses of the first and second relay devices to the connection mode inquiry, that the communication terminal and the destination terminal are connected to different relay devices via wired networks, the direct communication start instruction being an instruction to start the direct wireless communication between the first relay device and the second relay device.

Furthermore, the connection mode inquiring unit is configured to inquire, using the connection mode inquiry, about information on the access point wirelessly connected to the relay device in addition to information on the terminal connected via the wired network. In addition, the connection state switching unit may be further configured to transmit the direct communication start instruction to the first relay device when it is determined, based on the responses of the first and second devices to the connection mode inquiry, that the first relay device and the second relay device are wirelessly connected to the same access point, the direct communication start instruction being an instruction to start the direct wireless communication between the first relay device and the second relay device.

Furthermore, the communication terminal is connected to the first relay device via a third relay device that is connected to the communication terminal and the first relay device via wired networks and is wirelessly connected to a second access point that is different from the access point. In addition, the connection mode inquiring unit may be configured to transmit the connection mode inquiry to each of the first to third relay devices, and the connection state switching unit may be configured to transmit the direct communication start instruction to the first relay device when it is determined, based on responses of the first to third relay devices to the connection mode inquiry, that the third relay device to which the communication terminal is connected directly via the wired network is not wirelessly connected to the same access point as the second relay device, and the first terminal to which the communication terminal is connected indirectly via the wired network is connected to the same access point as the second terminal, the direction communication start instruction being an instruction to start the direction wireless communication between the first relay device and the second relay device.

With each of the configurations described above in which the connection information of the relay device is obtained in advance using the connection mode inquiry, the communication method can be timely switched even in such a complicated network with a plurality of access points.

A relay device according to an aspect of the present invention is a relay device which relays data between a communication terminal in a wireless communication system and the wireless communication system, the wireless communication system connecting to an access point for relaying data in wireless communication, a communication destination device wirelessly connected to the access point, and the communication terminal that performs wireless communication with the communication destination device. Specifically, the relay device includes: a wired communication interface connected to the communication terminal via a wired network; a wireless communication interface having a function of performing indirect wireless communication that is wireless communication via the access point, and direct wireless communication that is wireless communication not via the access point; a direct communication availability notification transmitting unit configured to transmit a direct communication availability notification to the communication terminal according to receipt of a direct communication availability inquiry from the communication terminal, the direct communication availability notification indicating that the direct wireless communication is available, and the direct communication availability inquiry being an inquiry about whether or not the function of performing the direct wireless communication is provided; and a connection state switching unit configured to switch communication between the wireless communication interface and the communication destination device, from the indirect wireless communication to the direct wireless communication, according to receipt of a direct communication start instruction from the communication terminal, the direct communication start instruction being an instruction to start the direct wireless communication with the communication destination device.

Using the notification from the communication terminal as a trigger to switch between the indirect wireless communication and the direct wireless communication as in the configuration described above enables timely switching of the communication method even in a relay device which itself does not execute applications.

Furthermore, the relay device may include: a storage unit configured to hold information on a terminal connected to the wired communication interface; and a connection information notification transmitting unit configured to transmit a connection information notification according to receipt of a connection information inquiry, the connection information notification indicating the information on the terminal, which is held by the storage unit, and the connection information inquiry being an inquiry about the information on the terminal connected to the relay device via the wired network.

Furthermore, the storage unit may be further configured to hold information on the access point connected to the wireless communication interface, and the connection information notification transmitting unit may be configured to transmit the information on the access point, which is held by the storage unit, in addition to the connection information notification, according to receipt of the connection information inquiry.

With each of the configurations described above in which the connection information of the relay device is obtained in advance using the connection mode inquiry, the communication method can be timely switched even in such a complicated network with a plurality of access points.

In a wireless communication system according to an aspect of the present invention, an access point and first and second communication devices are connected, the access point relaying data in wireless communication, and the first and second communication devices being wirelessly connected to the access point and performing wireless communication with each other. The first communication device includes: a first wireless communication interface having a function of performing indirect wireless communication that is wireless communication via the access point, and direct wireless communication that is wireless communication not via the access point; a direct communication availability inquiring unit configured to transmit a direct communication availability inquiry to the wireless communication system via the access point, the direct communication availability inquiry being an inquiry for searching for a device having the function of performing the direct wireless communication; and a first connection state switching unit configured to switch communication between the wired communication interface and the communication destination device, from the indirect wireless communication to the direct wireless communication, according to receipt of a direct communication availability notification from the second communication device in response to the direct communication availability inquiry, the direct communication availability notification indicating that the direct wireless communication is available. The second communication device includes: a second wireless communication interface having the function of performing the indirect wireless communication and the direct wireless communication; a direct communication availability transmitting unit configured to transmit the direct communication availability notification to the first communication device according to receipt of the direct communication availability inquiry from the first communication device; and a second connection state switching unit configured to switch communication between the second wireless communication interface and the first communication device, from the indirect wireless communication to the direct wireless communication, according to transmission of the direct communication availability notification to the first communication device.

A wireless communication control method according to an aspect of the present invention is a method of controlling wireless communication by switching communication between first and second communication devices, from indirect wireless communication that is wireless communication via an access point, to direct wireless communication that is wireless communication not via the access point, in a wireless communication system which connects the access point for relaying data in the wireless communication, and the first and second communication devices that perform the wireless communication with each other. Specifically, the method includes: transmitting a direct communication availability inquiry from the first communication device to the wireless communication system via the access point, the direct communication availability inquiry being an inquiry for searching for a device having a function of performing the direct wireless communication; transmitting a direct communication availability notification from the second communication device to the first communication device according to receipt of the direct communication availability inquiry from the first communication device, the direct communication availability notification indicating that the direct wireless communication is available; and switching communication between the first and second communication devices, from the indirect wireless communication to the direct wireless communication, according to receipt of the direct communication availability notification from the second communication device.

Confirming that a communication destination supports direct wireless communication, before switching between the indirect wireless communication and the direct wireless communication, as in the configuration described above, will improve communication reliability.

A program according to an aspect of the present invention causes a communication terminal which is connected to a wireless communication system connecting an access point for relaying data in wireless communication, and a communication destination device wirelessly connected to the access point, and performs wireless communication with the communication destination device, to execute: transmitting a direct communication availability inquiry to the wireless communication system via the access point, the direct communication availability inquiry being an inquiry for searching for a device having a function of performing direct wireless communication that is wireless communication not via the access point; and switching communication with the communication destination device, from indirect wireless communication to the direct wireless communication, according to receipt of a direct communication availability notification from the communication destination device in response to the direct communication availability inquiry, the indirect wireless communication being wireless communication via the access point, and the direct communication availability notification indicating that the direct wireless communication is available.

A program according to an aspect of the present invention causes a relay device which relays data between a communication terminal in a wireless communication system and the wireless communication system, the wireless communication system connecting an access point for relaying data in wireless communication, a communication destination device wirelessly connected to the access point, and the communication terminal that performs wireless communication with the communication destination device, to execute: transmitting a direct communication availability notification to the communication terminal according to receipt of a direct communication availability inquiry from the communication terminal, the direct communication availability notification indicating that direct wireless communication is available, and the direct communication availability inquiry being an inquiry about whether or not a function of performing the direct wireless communication is provided; and switching communication with the communication destination device from indirect wireless communication to the direct wireless communication according to receipt of a direct communication start instruction from the communication terminal, the direct communication start instruction being an instruction to start the direction wireless communication with the communication destination device.

It is to be noted that the present invention may be implemented not only as the communication terminal, the relay device, and so on described as above, but also as an integrated circuit which implements functions of the communication terminal, the relay device, and so on, and as a program which causes a computer to execute such functions. In addition, it goes without saying that such a program may be distributed via a recording medium such as a CD-ROM and a communication network such as the Internet. Moreover, the present invention may be implemented as an integrated circuit which implements functions of such a display device.

### ADVANTAGEOUS EFFECTS OF INVENTION

The present invention enables implementation of the direct link even in a case where a device incorporating no wireless communication means is connected to a relay device such as an Ethernet® converter, which allows for an effective use of the radio band.

### BRIEF DESCRIPTION OF DRAWINGS

FIG. 1 is a system configuration diagram according to the first embodiment of the present invention.

FIG. 2 is a block diagram showing a configuration of an EC according to the first embodiment of the present invention.

FIG. 3 shows a Device Description held by a device supporting DLS according to the present invention.

FIG. 4 is a block diagram showing a configuration of a client device according to the first embodiment of the present invention.

FIG. 5 is a sequence chart according to the first embodiment of the present invention.

FIG. 6 is a flowchart showing the behavior of a client device according to the first embodiment of the present invention.

FIG. 7 shows a connection mode management table held by the client device according to the first embodiment of the present invention.

FIG. 8 shows a connection mode management table obtained after a device supporting DLS is detected, according to the first embodiment of the present invention.

FIG. 9 shows a connection mode management table obtained after terminal connection information on the device supporting DLS is obtained, according to the first embodiment of the present invention.

FIG. 10 is a system configuration diagram according to the second embodiment of the present invention.

FIG. 11 is a flowchart showing the behavior of a client device according to the second embodiment of the present invention.

FIG. 12 shows a management table held by the client device according to the second embodiment of the present invention.

FIG. 13 shows a connection mode management table obtained after a device supporting DLS is detected, according to the second embodiment of the present invention.

FIG. 14 shows a management table obtained after terminal connection information on the device supporting DLS is obtained, according to the second embodiment of the present invention.

FIG. 15 is a system configuration diagram according to the third embodiment of the present invention.

FIG. 16 is a block diagram showing a configuration of a client device according to the third embodiment of the present invention.

FIG. 17 is a flowchart showing the behavior of a client device according to the third embodiment of the present invention.

FIG. 18 shows a connection mode management table held by the client device according to the third embodiment of the present invention.

FIG. 19 shows a connection mode management table obtained after a device supporting DLS is detected, according to the third embodiment of the present invention.

FIG. 20 shows a connection mode management table obtained after terminal connection information on the device supporting DLS is obtained, according to the third embodiment of the present invention.

FIG. 21 is a system configuration diagram according to the fourth embodiment of the present invention.

FIG. 22 is a flowchart showing the behavior of a client device according to the fourth embodiment of the present invention.

FIG. 23 shows a connection mode management table held by the client device according to the fourth embodiment of the present invention.

FIG. 24 shows a connection mode management table obtained after a device supporting DLS is detected, according to the fourth embodiment of the present invention.

FIG. 25 shows a connection mode management table obtained after terminal connection information and access point connection information of the device supporting DLS are obtained, according to the fourth embodiment of the present invention.

FIG. 26 shows a process sequence of conventional wireless communication.

### DESCRIPTION OF EMBODIMENTS

The following describes the best mode for implementing the present invention with reference to the drawings.

### First Embodiment

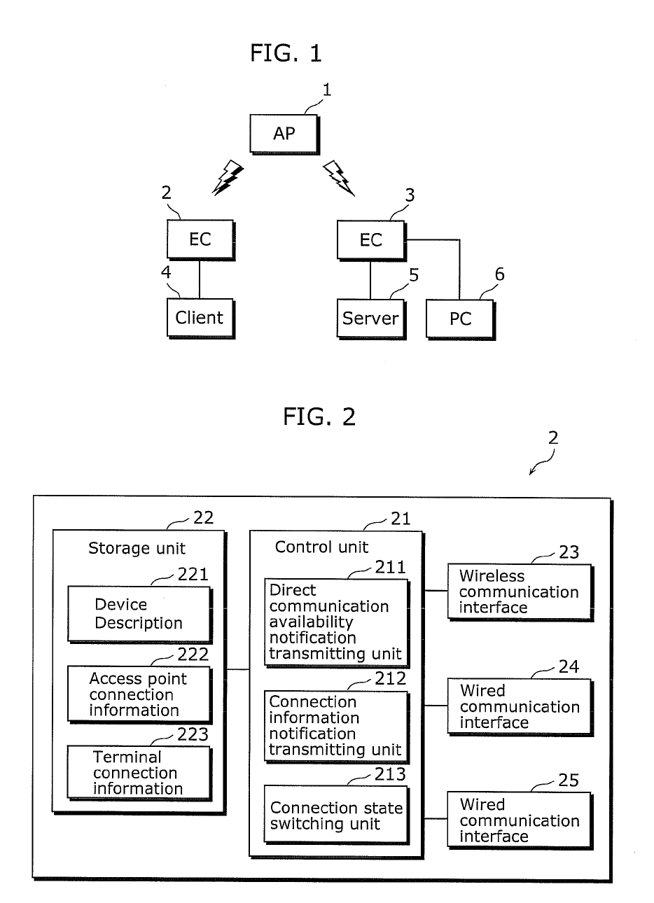

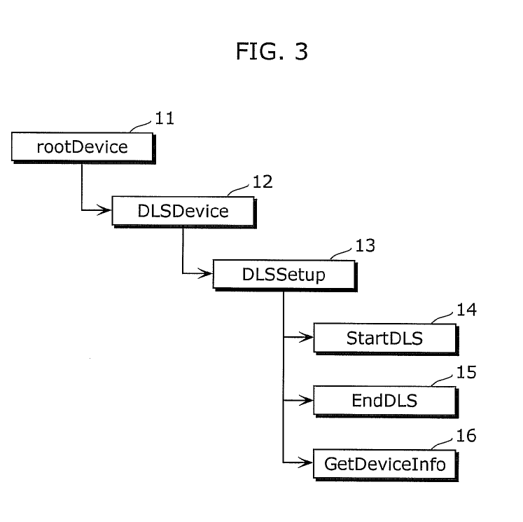

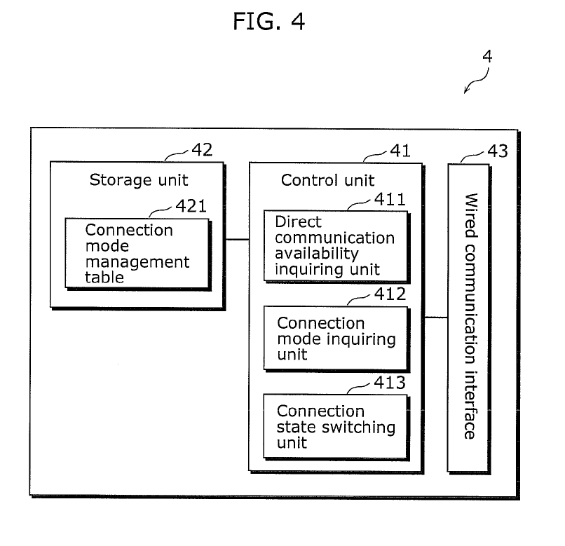

With reference to FIGS. 1 to 4, the wireless communication system according to the first embodiment of the present invention is described. FIG. 1 is a system configuration diagram of the wireless communication system according to the first embodiment, FIG. 2 is a block diagram showing a configuration of an EC 2, FIG. 3 is a configuration diagram of a Device Description 221 included in the EC 2, and FIG. 4 is a block diagram showing a configuration of a client device 4.

First, in a wireless communication system (which may also be referred to as “wireless communication network”) according to the first embodiment, an access point (which is hereinbelow denoted by “AP”) 1, Ethernet® converters (which are hereinbelow denoted by “EC”) 2 and 3, a client device 4, a server device 5, and a PC 6 are connected as shown in FIG. 1.

The AP 1 manages the wireless communication system. Specifically, the AP 1 is wirelessly connected to the EC 2 and the EC 3 and relays data transmitted by wireless communication between the EC 2 and the EC 3.

The EC 2 is a relay device which is connected to the client device 4 via wired network and relays data between the client device 4 and the wireless communication system. More specifically, EC 2 includes a control unit 21, a storage unit 22, a wireless communication interface 23, and one or more (two in the first embodiment) wired communication interfaces 24 and 25, as shown in FIG. 2.

The control unit 21 reads various programs stored in the storage unit 22 and operates as a direct communication availability notification transmitting unit 211, a connection information notification transmitting unit 212, a connection state switching unit 213, and so on. The storage unit 22 stores, in addition to the various programs, a Device Description 221 shown in FIG. 3, access point connection information 222 retaining information on an access point connected to the wireless communication interface 23, and terminal connection information 223 retaining information on terminals connected to the wired communication interfaces 24 and 25. The information retained in the access point connection information 222 and the terminal connection information 223 is updated at an appropriate time when connection to or disconnection from each of the communication interfaces is detected.

The direct communication availability notification transmitting unit 211 transmits, in response to receipt of a direct communication availability inquiry, a direct communication availability notification indicating that the direct wireless communication is available. The connection information notification transmitting unit 212 transmits, in response to receipt of a connection information inquiry, a connection information notification indicating the information (the information retained in the terminal connection information 223) on the terminals connected to the wired communication interfaces 24 and 25. The connection state switching unit 213 switches the communication of wireless communication interface 23 from the indirect wireless communication to the direct wireless communication. Specifically, it transmits a DLS Request in response to receipt of a direct communication start instruction; it transmits a DLS Response in response to receipt of a DLS Request.

The wireless communication interface 23 supports both the indirect wireless communication that is wireless communication via the AP 1 (infrastructure mode) and the direct wireless communication that is wireless communication not via the AP 1 (direct link). The wired communication interface 24 is connected to the client device 4 via wired network. In the first embodiment, the wired communication interface 25 of the EC 2 is not used.

The EC 2 has a function of Universal Plug and Pay-Device (UPnP-Device), and holds the Device Description 221 as shown in FIG. 3. The Device Description 221 retains, under a root Device 11, a DLS Device 12 indicating that the device supports DLS, a DLS Setup 13 that is a service which this device provides, and three actions (a Start DLS 14, an End DLS 15, and a Get Device Info 16) which this service provides. The ECs 2 and 3 provide an UPnP control point with these service and actions to perform DLS-related controls.

The Start DLS 14 is an action which instructs implementation of the DLS, and the End DLS 15 is an action which terminates the DLS being implemented. The Get Device Info 16 is an action for obtaining a list of devices connected to the communication interfaces 23, 24, and 25 of the ECs 2 and 3.

The wired communication interfaces 24 and 25 in the EC 3, which has the same configuration as the EC 2, are connected to the server device 5 and the PC 6, respectively.

The client device 4 includes a control unit 41, a storage unit 42, and a wired communication interface 43 as shown in FIG. 4.

The control unit 41 reads various programs stored in the storage unit 42 and operates as a direct communication availability inquiring unit 411, a connection mode inquiring unit 412, a connection state switching unit 413, and so on. The storage unit 42 stores, in addition to the various programs, a connection mode management table 421 in which connection modes of respective devices in the wireless communication system are stored. The wired communication interface 43 is connected to the wired communication interface 24 of the EC 2 via wired network.

The direct communication availability inquiring unit 411 transmits, to the wireless communication system, a direct communication availability inquiry about whether or not the device has a function of performing the direct wireless communication. The connection mode inquiring unit 412 transmits, to each of the ECs 2 and 3, a connection mode inquiry about information on terminals connected to the wired communication interfaces 24 and 25. The connection state switching unit 413 switches between the indirect wireless communication and the direct wireless communication. In the first embodiment, a direct communication start instruction to start the direct wireless communication between the EC 2 and the EC 3 is transmitted to the EC 2 in response to receipt of the direct communication availability notifications from both the EC 2 and the EC 3.

Now, functions of the server device 5 and the client device 4 are described. The server device 5 and the client device 4 are, for example, those such as the digital living network appliance (DLNA) certified devices each of which has a technique for connecting AV equipment, a personal computer, and a home information appliance to each other for linked use via a home LAN. Typically, the client device 4 is a television, and the server device 5 is a content server including a BD recorder and a DVD recorder. On the client device 4, the content stored in the server device 5 can be viewed using the home LAN.

The wireless communication system according to the first embodiment is a data stream distribution system using a wireless LAN, developed by the IEEE 802.11 Working Group TGe. The wireless LAN has an infrastructure mode (indirect wireless connection) in which communication is established under the control of an access point, and an ad-hoc mode (direct wireless connection) in which communication is established directly between terminals without control of access points. Furthermore, the IEEE 802.11 defines Direct Link Setup (DLS) for performing the direct communication between the terminals in the infrastructure mode.

When the DLS communication is necessary, the terminal which is about to start the DLS communication transmits, via an access point, a connection request (DLS Request) to a communication destination terminal with which the DLS communication is to be established. In the case where the terminal itself which receives the DLS Request has a DLS function, it transmits a response (DLS Response) back via the access point. Thus, the setting of the DLS is completed between the terminals.

However, upon a start of the DLS, the relay devices such as the ECs 2 and 3 that relay data and do not execute applications including content distribution do not know when the DLS starts and with which terminal the DLS is implemented in the wireless communication system. In order to start the DLS communication, it is therefore necessary to know the start time and the information on the communication destination.

This first embodiment describes operations of the respective devices for viewing, on the client device 4, the content stored in the server device 5. Suppose that neither the client device 4 nor the server device 5 incorporate functions of wireless communication. This means that all the applications which use the wireless communication system are to be executed using the ECs 2 and 3.

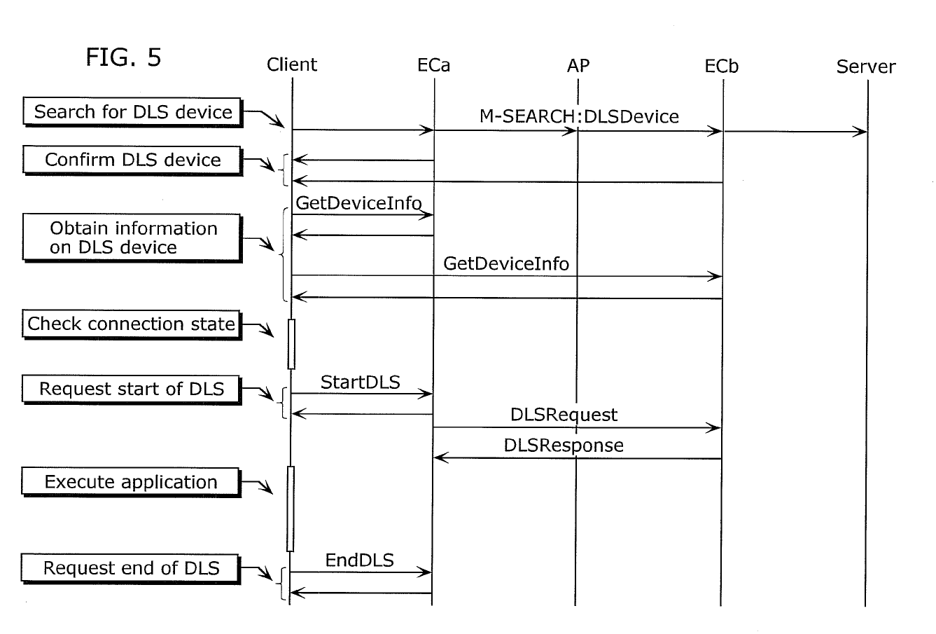

Next, a sequence in which the client device 4 reproduces the content stored in the server device 5 in the wireless communication system shown in FIG. 1 is described with reference to FIG. 5.

The client device 4 searches for a device supporting DLS, using UPnP (M-SEARCH). Specifically, the direct communication availability inquiring unit 411 multicasts the direct communication availability inquiry (M-SEARCH) onto the wireless communication system.

The ECs 2 and 3 that are the devices supporting DLS transmit respective responses to the client device 4. Specifically, the direct communication availability notification transmitting unit 211 in each of the ECs 2 and 3 transmits, to the client device 4, the direct communication availability notification indicating that the device supports DLS, in response to receipt of the direct communication availability inquiry from the client device 4. The client device 4 receives the direct communication availability notification from the ECs 2 and 3 and can thereby confirm the existence of the device supporting DLS in the network to which the client device 4 belongs.

Next, the connection mode inquiring unit 412 of the client device 4 transmits a connection mode inquiry (Get Device Info) to each of the devices supporting DLS (ECs 2 and 3), and obtains the connection information.

Next, each of the ECs 2 and 3 transmits its connection information as a response. Specifically, in response to receipt of the connection mode inquiry, the connection information notification transmitting unit 212 in each of the ECs 2 and 3 transmits, to the client device 4, a connection information notification stating the information (the information retained in the terminal connection information 223) on the terminals connected to the wired communication interfaces 24 and 25. The client device 4 receives the connection information notification and can thereby check the connection state of each of the ECs 2 and 3.

It is to be noted that all the communication between the client device 4 and the EC 3 in the above steps is the indirect wireless communication that is performed via the AP 1.

Subsequently, when the client device 4 determines that there is a wireless communication system in a communication path to the server device 5 and that the DLS is available and can be implemented, the client device 4 then issues a Start DLS to the EC 2 to request a start of the DLS with the EC 3. Specifically, the connection state switching unit 213 of the client device 4 transmits, to the EC 2, a direct communication start instruction (Start DLS) for starting the direct wireless communication between the EC 2 and the EC 3.

The connection state switching unit 213 of the EC 2 issues the DLS Request to the EC 3 in response to receipt of the direct communication start instruction. The connection state switching unit 213 of the EC 3 issues the DLS Request to the EC 2 in response to receipt of the DLS Request from the EC 2. Thus, between the EC 2 and the EC 3, the direct wireless communication not via the AP 1 is performed.

The client device 4 then executes an application for viewing of content. At this time, the direct wireless communication is performed between the EC 2 and the EC 3, which allows for an efficient use of the radio band and allows for reduced noise in a video to be viewed. Subsequently, when this application ends, the client device 4 then issues an End DLS to the EC 2 to instruct an end of the DLS. Specifically, the connection state switching unit 213 of the client device 4 transmits, to the EC 2, a direct communication end instruction to terminate the direct wireless communication between the EC 2 and the EC 3. After this, between the EC 2 and the EC 3, the indirect wireless communication via the AP 1 is performed.

Among the above processes, the DLS Request and the DLS Response are provided in the second layer of the OSI reference model. The other processes are provided in the third and following layers (typically, the seventh layer) of the OSI reference model.

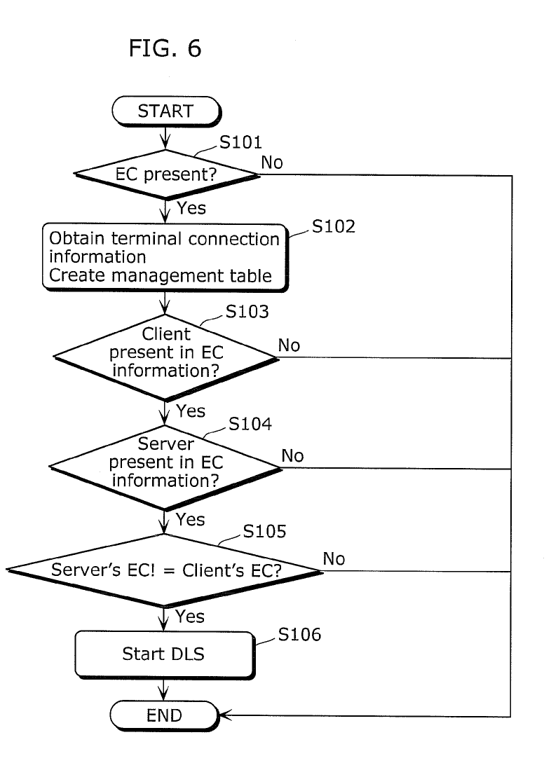

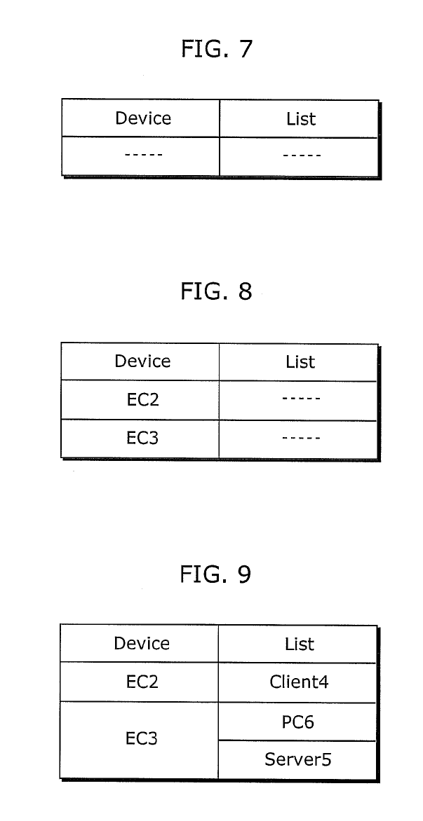

Next, specific operations of the client device 4 are described with reference to the flowchart shown in FIG. 6. The client device 4 has a connection mode management table 421 as shown in FIG. 7. This connection mode management table 421 states information on the devices supporting DLS (in the column of “Device”) and the devices connected via wired network to the respective devices supporting DLS (in the column of “List”). At a point in time when the client device 4 is activated, no information is stated in the connection mode management table 421 in the first embodiment as shown in FIG. 7.

Before executing an application, the client device 4 first searches for the device supporting DLS in order to check whether or not there is a wireless section in the network to which the client device 4 itself belongs (S101). In this first embodiment, since the UPnP is used, the DLS Device is searched for using the M-SEARCH. More specifically, the direct communication availability inquiring unit 411 of the client device 4 multicasts the direct communication availability inquiry onto all the devices in the wireless communication system.

Subsequently, the client device 4 monitors receipt of a response (the direct communication availability notification) to the direct communication availability inquiry for a predetermined time. When no response is received even after the predetermined time, it is determined that there are no devices supporting DLS in the wireless communication system (No in S101), which ends the processing shown in FIG. 6. After this, using the indirect wireless communication via the AP 1, the client device 4 performs communication with the server device 5.

In this first embodiment, the EC 2 and the EC 3 support DLS. This means that the direct communication availability notification transmitting unit 211 in each of the ECs 2 and 3 transmits the direct communication availability notification to the client device 4 in response to receipt of the direct communication availability inquiry from the client device 4.

The client device 4 which has received the direct communication availability notification (Yes in S101) adds, to the connection mode management table 421, information on the source which transmitted the direct communication availability notification. In this first embodiment, the information on the EC 2 and the information on the EC 3 are added as shown in FIG. 8.

Next, the client device 4 obtains, using the Get Device Info, a list of devices connected to the wired communication interfaces 24 and 25 of each of the ECs 2 and 3 (S102). Specifically, the connection mode inquiring unit 412 of the client device 4 transmits a connection mode inquiry to the ECs 2 and 3.

Each of the ECs 2 and 3 which has received the connection mode inquiry transmits, to the client device 4, a connection information notification stating information on the devices connected to a corresponding one of the ECs 2 and 3 via wired network. In this embodiment, the connection information notification transmitting unit 212 of the EC 2 transmits the connection information notification which states the client device 4 as a connected device. In the meantime, the connection information notification transmitting unit 212 of the EC 3 transmits the connection information notification which states information on the server device 5 and the PC 6 as connected devices.

The client device 4 which has received the connection information notification from each of the ECs 2 and 3 adds, to the connection mode management table 421, content stated in the connection information notification. Specifically, as shown in FIG. 9, the list in the EC 2 will include information on the client device 4, and the list in the EC 3 will include information on the PC 6 and the server device 5.

Next, the client device 4 checks whether or not the created connection mode management table 421 includes the information on the client device 4 itself (S103). When the connection mode management table 421 does not include the information on the client device 4 itself (No in S103), the client device 4 determines that the client device 4 is connected to no wireless communication systems, thus ending the processing of FIG. 6 and then executing the application.

On the other hand, when the connection mode management table 421 includes the information on the client device 4 itself (Yes in S103), the client device 4 checks whether or not the connection mode management table 421 includes the information on the server device 5 that is a communication destination for execution of the application (S104). When it does not include the information on the server device 5 (No in S104), the client device 5 determines that the server device 5 is not directly connected to the wireless communication system (for example, that the server device 5 is connected by wiring to the AP 1), thus ending the processing of FIG. 6 and then executing the application.

On the other hand, when the connection mode management table 421 includes the information on the server device 5 (Yes in S104), the client device 4 checks whether or not the relay device connected to the client device 4 itself is the same as the relay device connected to the server device 5 (S105).

When the connected relay devices are the same (No in S105), the client device 4 determines that there are no wireless sections between the client device 4 itself and the server device 5, thus ending the processing of FIG. 6 and then executing the application.

In this first embodiment, since the client device 4 is connected to the EC 2, and the server device 5 is connected to the EC 3, it will be found that the client device 4 and the server device 5 are not connected to the same relay device. When the client device 4 finds that the relay devices connected to the client device 4 itself and the server device 5 are different from each other (Yes in S105), then the client device 4 issues, to the EC 2 connected to the client device 4, an action for DLS implementation, namely, a Start DLS to which the information on the EC 3 has been added (S106). Specifically, the connection state switching unit 413 of the client device 4 transmits, to the EC 2, a direct communication start instruction to start the direct wireless communication between the EC 2 and the EC 3.

The EC 2 which has received the direct communication start instruction from the client device 4 issues a DLS Request to the EC 3. The EC 3 which has received the DLS Request issues a DLS Response to the EC 2. This starts the direct wireless communication between the EC 2 and the EC 3.

After completion of the above processing, the client device 4 executes the application by downloading data from the server device 5, for example. At this time, between the EC 2 and the EC 3, the direct wireless communication not via the AP 1 is performed.

When the application ends, the client device 4 issues, to the EC 2 connected to the client device 4, an action for DLS implementation, namely, an End DLS to which the information on the EC 3 has been added. Specifically, the connection state switching unit 413 of the client device 4 transmits, to the EC 2, a direct communication end instruction to terminate the direct wireless communication between the EC 2 and the EC 3. After this, between the EC 2 and the EC 3, the indirect wireless communication via the AP 1 is performed.

By employing the above method, it is possible to timely implement the direct link even in the wireless communication system which includes devices incorporating no wireless functions (the client device 4 and the server device 5 in the first embodiment).

### Second Embodiment

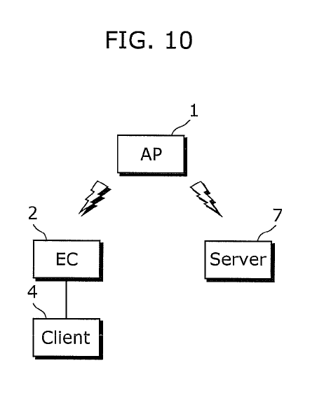

FIG. 10 is a system configuration diagram according to the second embodiment of the present invention. What is different from the first embodiment is that a server device 7 incorporates a wireless function. That is, the server device 7 according to the second embodiment has functions of the EC 3 in addition to functions of the server device 5. In terminal connection information held by the server device 7, information on the server device 7 itself is stated.

The server device 7 and the EC 2 are connected to the wireless communication system managed by the AP 1. Furthermore, to the wired communication interface 24 of the EC 2, the client device 4 is connected. In addition, each of the server device 7 and the EC 2 has the UPnP function and supports DLS as in the case of the first embodiment.

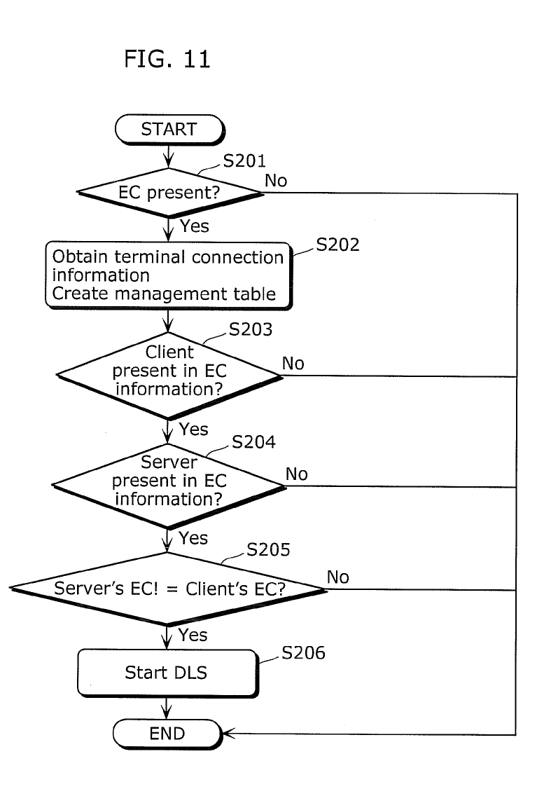

Next, specific operations of the client device 4 in the above configuration are described with reference to the flowchart shown in FIG. 11. It is to be noted that, since S201 to S206 of FIG. 11 correspond respectively to S101 to S106 of FIG. 6, detailed descriptions on the common points with the first embodiment are omitted, and unique points of the second embodiment are described in detail.

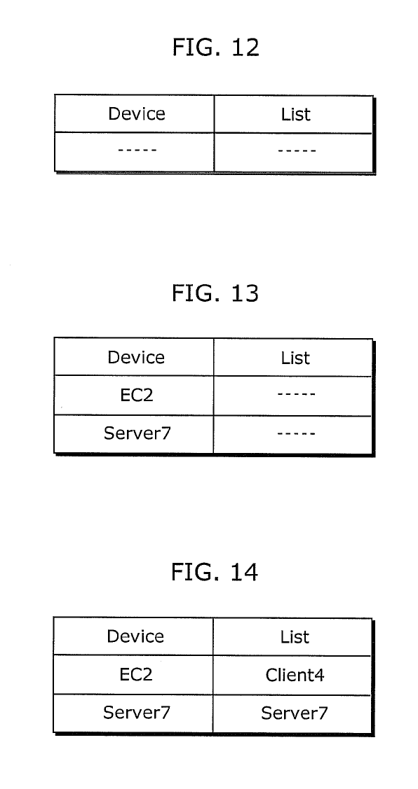

The client device 4 creates and holds the connection mode management table 421 in which a device supporting DLS and a device connected via wired network to the device supporting DLS are stated as shown in FIG. 12. Before executing an application, the client device 4 first searches for the device supporting DLS in order to check whether or not there is a wireless section in the network to which the client device 4 itself belongs (S201).

In this second embodiment, since the UPnP is used, the DLS Device is searched for using the M-SEARCH. When there are no devices supporting DLS (No in S201), the client device 4 ends the processing of FIG. 11 and then executes the application. In this second embodiment, each of the EC 2 and the server device 7 supports DLS and therefore transmits the direct communication availability notification to the client device 4.

The client device 4 which has received the direct communication availability notification from each of the EC 2 and the server device 7 (Yes in S201) adds, to the devices in the connection mode management table 421, information on the EC 2 and the server device 7, as shown in FIG. 13.

Subsequently, the client device 4 obtains terminal connection information on the devices supporting DLS (S202). In this second embodiment, a list of devices connected to the EC 2 and the server device 7 is obtained using the Get Device Info. Referring to the connection state of FIG. 10, the connection information notification of the EC 2 includes information on the client device 4, and the connection information notification of the server device 7 includes information on the server device 7 itself.

The client device 4 which has received this information adds the client device 4 and the server device 7 to the list for the respective devices in the connection mode management table 421. The created management table is that as shown in FIG. 14.

Next, the client device 4 checks whether or not the created connection mode management table 421 includes the information on the client device 4 itself (S203). When the connection mode management table 421 does not include the information on the client device 4 itself (No in S203), the client device 4 determines that the client device 4 is connected to no wireless communication systems, thus ending the processing of FIG. 11 and then executing the application.

On the other hand, when the connection mode management table 421 includes the information on the client device 4 itself (Yes in S203), the client device 4 checks whether or not the connection mode management table 421 includes the information on the server device 7 that is a communication destination for execution of the application (S204). When it does not include the information on the server device 7 (No in S204), the client device 4 determines that the server device 7 is not directly connected to the wireless communication system (for example, that the server device 7 is connected by wiring to the AP 1), thus ending the processing of FIG. 11 and then executing the application.

On the other hand, when the connection mode management table 421 includes the information on the server device 7 (Yes in S204), the client device 4 checks whether or not the relay device connected to the client device 4 itself is the same as the relay device connected to the server device 7 (which relay device is the server device 7) (S205).

When the connected relay devices are the same (No in S205), the client device 4 determines that there are no wireless sections between the client device 4 itself and the server device 7, thus ending the processing of FIG. 11 and then executing the application.

In this second embodiment, since the client device 4 is connected to the EC 2, and the server device 7 incorporates a function of a relay device, it will be found that the client device 4 and the server device 7 are not connected to the same relay device.

When the client device 4 finds that the relay devices connected to the client device 4 itself and the server device 7 are different from each other (Yes in S205), then the client device 4 issues, to the EC 2 connected to the client device 4, an action for DLS implementation, namely, a Start DLS to which the information on the server device 7 has been added (S206). The client device 4 then executes the application.

When the application ends, the client device 4 issues, to the EC 2 connected to the client device 4, an action for DLS implementation, namely, an End DLS to which the information on the server device 7 has been added.

By employing the above method, it is possible to timely implement the direct link even in the wireless communication system which includes a device incorporating no wireless functions (the client device 4) and a device incorporating a wireless function (the EC 2 and the server device 7).

### Third Embodiment

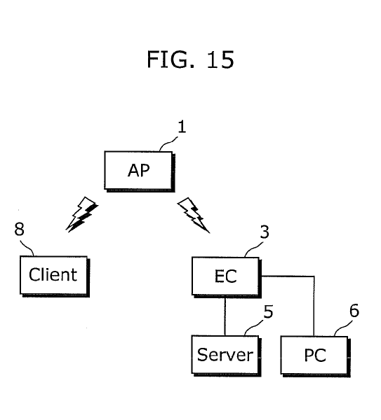

FIG. 15 is a system configuration diagram according to the third embodiment of the present invention. What is different from the first embodiment is that a client device 8 incorporates a wireless function. That is, the client device 8 according to the third embodiment has functions of the EC 2 shown in FIG. 2 in addition to functions of the client device 4.

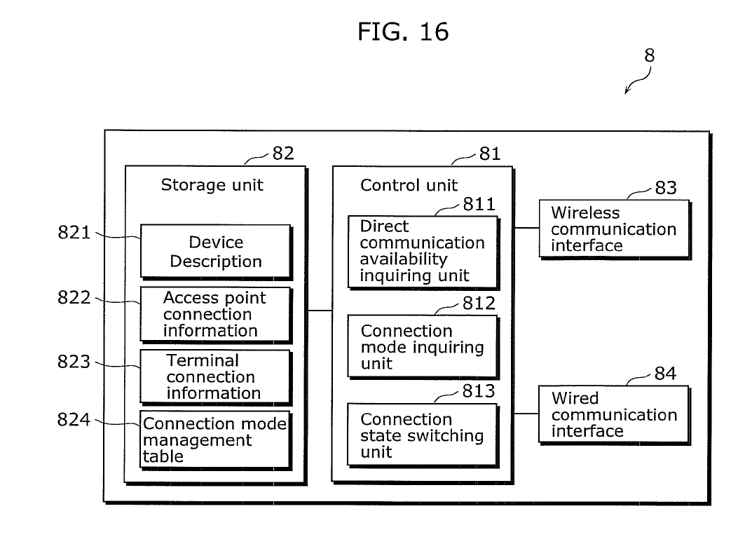

More specifically, as shown in FIG. 16, the client device 8 includes: a control unit 81 operating as a direct communication availability inquiring unit 811, a connection mode inquiring unit 812, and a connection state switching unit 813; a storage unit 82 storing a Device Description 821, access point connection information 822, terminal connection information 823, and connection mode management table 824; a wireless communication interface 83; and a wired communication interface 84. In the terminal connection information 823 of the client device 8, information on the client device 8 itself is stated in advance. The functions of these units have already been described with reference to FIGS. 2 and 4 and therefore are not described below.

The client device 8 and the EC 3 are connected to the wireless communication system managed by the AP 1. Furthermore, to the wired communication interfaces 24 and 25 of the EC 3, the server device 5 and the PC 6 are connected. In addition, each of the client device 8 and the EC 3 has the UPnP function and supports DLS as in the case of the first embodiment.

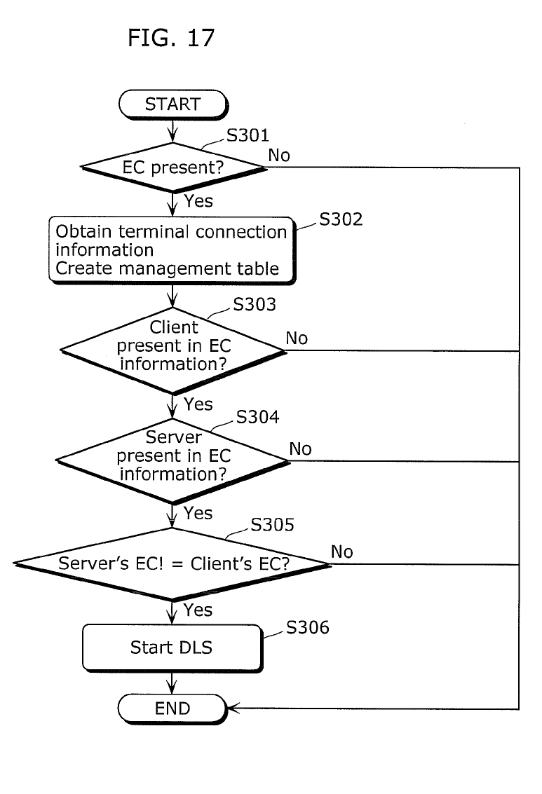

Next, specific operations of the client device 8 in the above configuration are described with reference to the flowchart shown in FIG. 17. It is to be noted that, since S301 to S306 of FIG. 17 correspond respectively to S101 to S106 of FIG. 6, detailed descriptions on the common points with the first embodiment are omitted, and unique points of the third embodiment are described in detail.

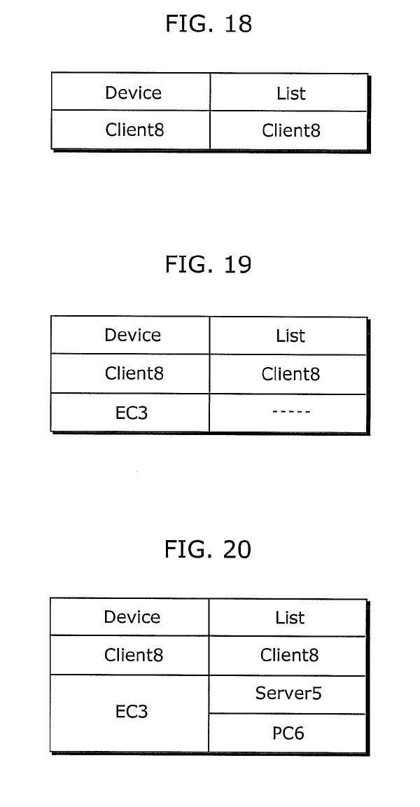

The client device 8 creates and holds a connection mode management table 824 in which a device supporting DLS and a device connected via wired network to the device supporting DLS are stated as shown in FIG. 18. The client device 8 incorporates a function of a relay device (which means that the client device 8 is a wireless function embedded device) and therefore adds its own information to the connection mode management table 824 in advance. In this case, the client device 8 is stated for each of the device and the list.

Before executing an application, the client device 8 first searches for the device supporting DLS in order to check whether or not there is a wireless section in the network to which the client device 8 itself belongs (S301).

In this third embodiment, since the UPnP is used, the DLS Device is searched for using the M-SEARCH. When there are no devices supporting DLS (No in S301), the client device 8 ends the processing of FIG. 17 and then executes the application.

In this third embodiment, the EC 3 supports DLS and therefore transmits the direct communication availability notification to the client device 8. When the client device 8 receives the direct connection availability notification from the EC 3 (Yes in S301), then the client device 8 adds the EC 3 to the device in the connection mode management table 824 as shown in FIG. 19.

Subsequently, the client device 8 obtains terminal connection information on the EC 3 (S302). In this third embodiment, a list of devices connected to the wired communication interfaces 24 and 25 of the EC 3 is obtained using the Get Device Info. Referring to the connection state of FIG. 15, the connection information notification of the EC 3 includes information on the server device 5 and the PC 6.

The client device 8 which has received this information adds the server device 5 and the PC 6 to the list for the respective devices in the connection mode management table 824. The created connection mode management table 824 is that as shown in FIG. 20.

Next, the client device 8 checks whether or not the created connection mode management table 824 includes the information on the client device 8 itself (S303). When the connection mode management table 824 does not include the information on the client device 8 itself (No in S303), the client device 8 determines that the client device 8 is connected to no wireless communication systems, thus ending the processing of FIG. 17 and then executing the application.

On the other hand, when the connection mode management table 824 includes the information on the client device 8 itself (Yes in S303), the client device 8 checks whether or not the connection mode management table 824 includes the information on the server device 5 that is a communication destination for execution of the application (S304). When it does not include the information on the server device 5 (No in S304), the client device 8 determines that the server device 5 is not directly connected to the wireless communication system (for example, that the server device 5 is connected by wiring to the AP 1), thus ending the processing of FIG. 17 and then executing the application.

On the other hand, when the management table includes the server device 5 (Yes in S304), then the client device 8 checks whether or not the relay device connected to the client device 8 itself is the same as the relay device connected to the server device 5 (S305). When the connected relay devices are the same (No in S305), the client device 8 determines that there are no wireless sections between the client device 8 itself and the server device 5, thus ending the processing of FIG. 17 and then executing the application.

In this third embodiment, since the server device 5 is connected to the EC 3, and the client device 8 incorporates a function of a relay device (a wireless function), it will be found that the client device 8 and the server device 5 are not connected to the same relay device.

When the client device 8 finds that the relay devices connected to the client device 8 itself and the server device 5 are different from each other (Yes in S305), then the client device 8 issues, to the connection state switching unit 813 of the client device 8 itself, an action for DLS implementation, namely, a Start DLS to which the information on the EC 3 has been added (S306). At this time, the connection state switching unit 813 of the client device 8 issues a DLS Request to the EC 3. The EC 3 which has received the DLS Request issues a DLS Response to the client device 8. This starts the direct wireless communication between the client device 8 and the EC 3.

After completion of the above processing, the client device 8 executes the application by downloading data from the server device 5, for example. At this time, between the client device 8 and the EC 3, the direct wireless communication not via the AP 1 is performed.

When the application ends, the client device 8 issues, to the connection state switching unit 813 of the client device 8 itself, an action for DLS implementation, namely, an End DLS to which the information on the EC 3 has been added. By employing the above method, it is possible to timely implement the direct link even in the wireless communication system which includes a device incorporating no wireless functions (the server device 5) and a device incorporating a wireless function (the EC 3 and the client device 8).

### Fourth Embodiment

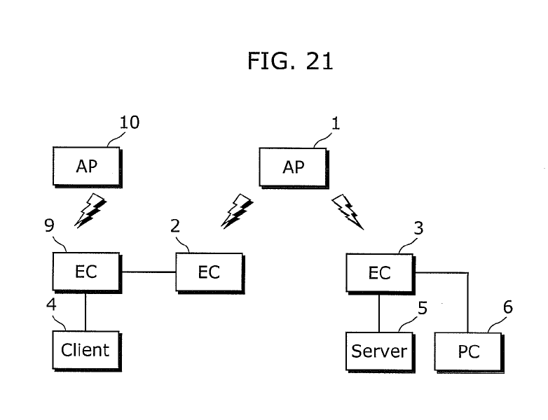

FIG. 21 is a system configuration diagram according to the fourth embodiment of the present invention. What is different from the first embodiment is that an EC 9 and an AP 10 are added to the wireless communication system according to the first embodiment. Specifically, to the wired communication interfaces 24 and 25 of the EC 9, the EC 2 and the client device 4 are connected. This means that the client device 4 accesses, via the EC 9 and the EC 2, the wireless communication system managed by the AP 1. Furthermore, the EC 9 is wirelessly connected to the AP 10 that is different from the AP 1. The AP 1 and the AP 10 are adapted for networks which are entirely different from each other using different frequencies, SSIDs, and so on. In addition, each of the ECs 2, 3, and 9 has the UPnP function and supports DLS as described in the first embodiment.

In the fourth embodiment, the connection mode inquiring unit 412 of the client device 4 inquires about not only information on a device connected via wired network to a device supporting DLS, but also information on an access point wirelessly connected to the device supporting DLS. Furthermore, the connection information notification transmitting unit 212 of each of the ECs 2, 3, and 9 transmits not only the information on terminals which is retained in the terminal connection information 223, but also the information on access points which is retained in the access point connection information 222.

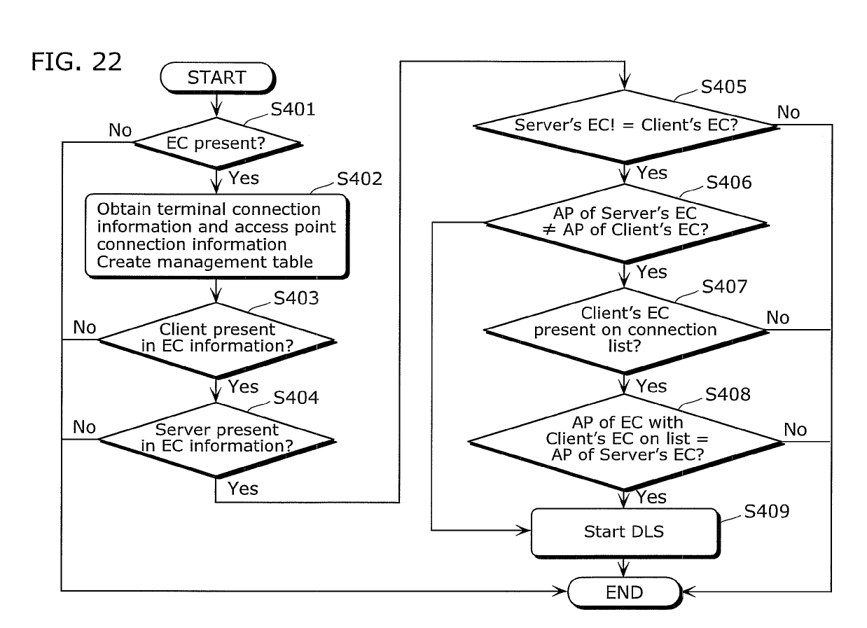

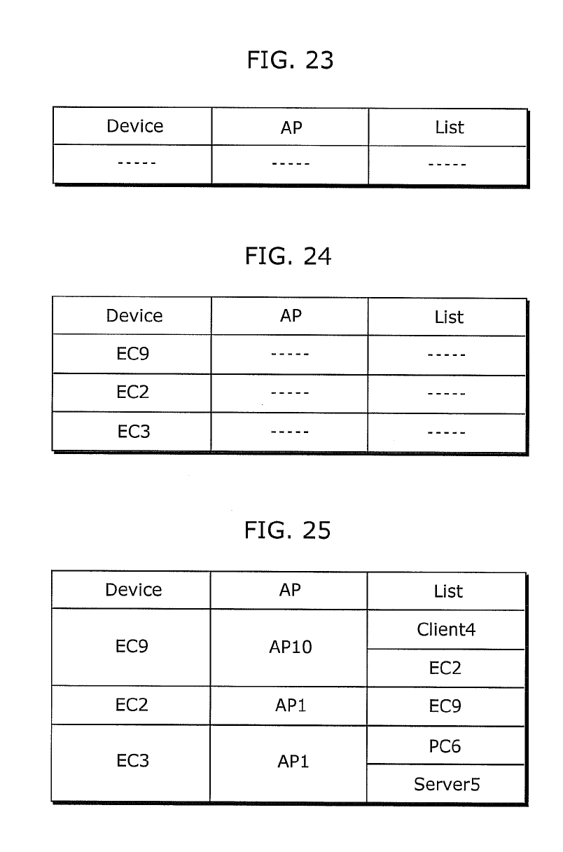

Next, specific operations of the client device 4 in the above configuration are described with reference to the flowchart shown in FIG. 22. It is to be noted that, since S401 to S405 and S409 of FIG. 22 correspond respectively to S101 to S106 of FIG. 6, detailed descriptions on the common points with the first embodiment are omitted, and unique points of the fourth embodiment are described in detail.

The client device 4 creates and holds the connection mode management table 421 which states information on the devices supporting DLS (in the column of “Device”), the devices connected via wired network to the respective devices supporting DLS (in the column of “List”), and the access points of the wireless communication system to which each of the devices supporting DLS belongs (in the column of “AP”).

Before executing an application, the client device 4 first searches for the device supporting DLS in order to check whether or not there is a wireless section in the network to which the client device 4 itself belongs (S401).

In this fourth embodiment, since the UPnP is used, the DLS Device is searched for using the M-SEARCH. When there are no devices supporting DLS (No in S401), the client device 4 ends the processing of FIG. 22 and then executes the application.

When the client device 4 receives the direct connection availability notification from the EC 2, EC 3, and EC 9 (Yes in S401), then the client device 4 adds the EC 2, EC 3, and EC 9 to the device in the connection mode management table 421 as shown in FIG. 24.

Next, the client device 4 obtains terminal connection information and access point connection information of the ECs 2, 3, and 9 (S402). In the fourth embodiment, it obtains, using the Get Device Info, not only the list of the devices connected to the wired communication interfaces 24 and 25 of each of the ECs 2, 3, and 9, but also the information on the access points connected to the wireless communication interface 23 of each of the ECs 2, 3, and 9.

In this fourth embodiment, referring to the connection state of FIG. 21, the connection information notification which the EC 2 transmits includes information on the EC 9 as the terminal information, and information on the AP 1 as the access point information. The connection information notification which the EC 3 transmits includes information on the server device 5 and the PC 6 as the terminal information, and information on the AP 1 as the access point information. The connection information notification which the EC 9 transmits includes information on the EC 2 and the client device 4 as the terminal information, and information on the AP 10 as the access point information.

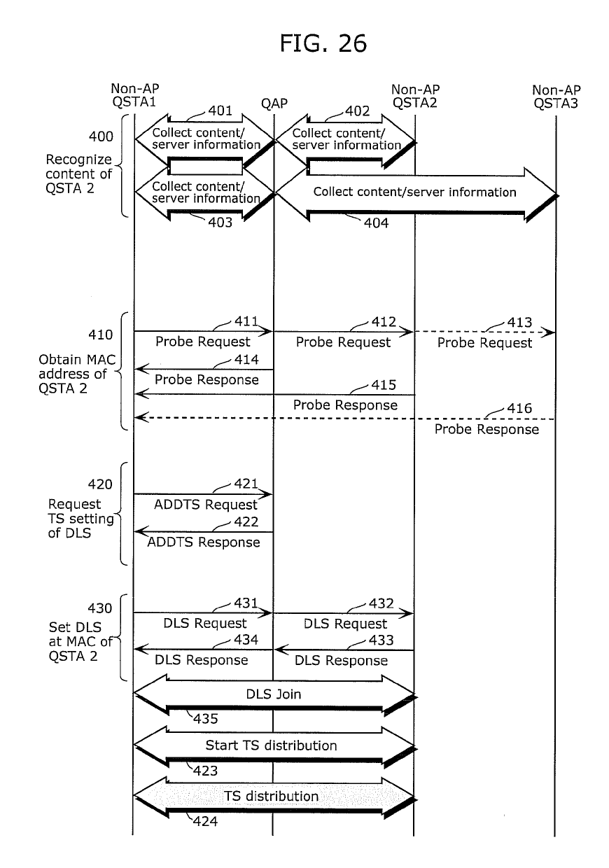

The client device 4 which has received the connection information notification from each of the ECs 2, 3 and 9 adds the above information to the connection mode management table 421. The connection mode management table 421 obtained after the addition is shown in FIG. 25.

Next, the client device 4 checks whether or not the created connection mode management table 421 includes the information on the client device 4 itself (S403). When the connection mode management table 421 does not include the information on the client device 4 itself (No in S403), the client device 4 determines that the client device 4 is connected to no wireless communication systems, thus ending the processing of FIG. 22 and then executing the application.

On the other hand, when the connection mode management table 421 includes the information on the client device 4 itself (Yes in S403), the client device 4 checks whether or not the connection mode management table 421 includes the information on the server device 5 that is a communication destination for execution of the application (S404). When it does not include the information on the server device 5 (No in S404), the client device 4 determines that the server device 5 is not directly connected to the wireless communication system (for example, that the server device 5 is connected by wiring to the AP 1), thus ending the processing of FIG. 22 and then executing the application.

On the other hand, when the management table includes the server device 5 (Yes in S404), then the client device 4 checks whether or not the relay device connected to the client device 4 itself is the same as the relay device connected to the server device 5 (S405). When the connected relay devices are the same (No in S405), the client device 4 determines that there are no wireless sections between the client device 4 itself and the server device 5, thus ending the processing of FIG. 22 and then executing the application.

In this fourth embodiment, since the client device 4 is connected to the EC 9, and the server device 5 is connected to the EC 3, it will be found that the client device 4 and the server device 5 are not connected to the same relay device.

When the client device 4 finds that the client device 4 and the server device 5 are connected to different relay devices (Yes in S405), then the client device 4 compares the information on access points of the wireless communication system to which the relay device connected to the server device 5 belongs, with the information on access points of the wireless communication system to which the relay device connected to the client device 4 itself belongs (S406). When the information on access points is the same (No in S406), the client device 4 determines that the relay device connected to the server device 5 and the relay device connected to the client device 4 belong to the same wireless communication system.

On the other hand, when the information on access points is different (Yes in S406), the client device 4 determines that the relay device connected to the server device 5 and the relay device connected to the client device 4 do not belong to the same wireless communication system. The client device 4 then determines whether or not the EC 9 connected to the client device 4 itself is on the list (S407). When the EC 9 is not on the list (No in S407), the client device 4 ends the processing of FIG. 22 and then executes the application.

On the other hand, when the EC 9 is on the list (Yes in S407), the client device 4 compares the access point of the wireless communication system to which the relay device with the relay device to which the client device 4 itself is connected, on the connection list, belongs, with the access point of the wireless communication system to which the relay device connected to the server device 5 belongs (S408). When these are not the same (No in S408), the client device 4 ends the processing of FIG. 22 and then executes the application.

With the configuration according to this fourth embodiment, the relay device with the EC 9, to which the client device 4 is connected, on the list, is the EC 2, and the access point of the wireless communication system to which the EC 2 belongs is the AP 1. In the meantime, the relay device connected to the server device 5 is the EC 3, and the access point of the wireless communication system to which the EC 3 belongs is the AP 1.

Thus, the access points to which the EC 2 and the EC 3 are connected are the same (Yes in S408), and the client device 4 therefore issues, to the EC 2 with the EC 9, to which the client device 4 itself is connected, on the connection list, an action for DLS implementation, namely, a Start DLS to which the information on the EC 3 with the server device 5 in the connection information has been added (S409).

When the application ends, the client device 4 issues, to the EC 2 with the EC 9, to which the client device 4 itself is connected, an action for DLS implementation, namely, an End DLS to which the information on the EC 3 with the server device 5 in the connection information has been added.

By employing the above method, it is possible to timely implement the direct link even in the case where there are a plurality of wireless communication systems. As a variation of the fourth embodiment, even in the case where the EC 9 is connected between the EC 3 and the server device 5, and the EC 9 is connected to the AP 10 that is different from the AP 1, the direct wireless communication can be performed between the EC 2 and the EC 3.

While the UPnP is used herein to confirm the devices supporting DLS and to obtain the connection information, it goes without saying that the communication protocol may be other protocols. Furthermore, while the Ethernet® converter is mentioned as a device that relays data between the wireless network and the wired network, it goes without saying that the communication interface may not be the Ethernet®. In addition, since the present invention is devised to timely implement the communication between the relay devices, the wireless MAC protocol for performing the communication between the relay devices is not limited to the DLS of the IEEE 802.11e.

Furthermore, the control process in each of the above embodiments may be implemented by a dedicated H/W (an electronic circuit or the like) and may alternatively be implemented by causing a CPU to perform interpretive execution of predetermined program data with which the above-described processing stored in the storage device (ROM, RAM, hard disk, etc.) can be executed. In this case, the program data may be introduced into the storage device by way of a recording medium and may alternatively be directly executed from the recording medium. The recording medium represents: a semiconductor memory such as a ROM, a RAM, and a flash memory; a magnetic disk memory such as a flexible disk and a hard disk; an optical disc such as a CD-ROM, a DVD, and a BD; a memory card such as an SD card; and the like. In addition, the recording medium includes, as a concept, communication media such as a telephone line and a transmission line.

While the embodiments of the present invention have been described above with reference to the drawings, the present invention is not limited to the illustrated embodiments. Various modifications and variations may be made to the illustrated embodiments within the literal or equivalent scope of the claimed invention. Moreover, constituents in the plurality of embodiments may be combined in any manner without departing from the spirit or scope of the present invention.

### INDUSTRIAL APPLICABILITY

The communication control method according to an implementation of the present invention is useful in a network which includes a wireless communication between relay devices in the case where devices incorporating no wireless functions are connected to the relay devices and the relay devices make up a wireless communication system.

### REFERENCE SIGNS LIST

1, 10 Access point
2, 3, 9 Ethernet® converter
4, 8 Client device
5, 7 Server device
6 PC
11 root Device
12 DLS Device
13 DLS Setup
14 Start DLS
15 End DLS
16 Get Device Info
21, 41, 81 Control unit
22, 42, 82 Storage unit
23, 83 Wireless communication interface
24, 25, 43, 84 Wired communication interface
211 Direct communication availability notification transmitting unit
212 Connection information notification transmitting unit
213, 413, 813 Connection state switching unit
221, 821 Device Description
222, 822 Access point connection information
223, 823 Terminal connection information
411, 811 Direction communication availability inquiring unit
412, 812 Connection mode inquiring unit
421, 824 Connection mode management table

1-13. (canceled)

14. A communication terminal which is connected to a wireless communication system in which an access point and a communication destination device are connected, and performs wireless communication with the communication destination device, the access point relaying data in wireless communication, and the communication destination device being wirelessly connected to the access point, wherein said communication terminal is connected, via a wired network, to a first relay device that relays data between said communication terminal and the wireless communication system so that said communication terminal is connected indirectly to the wireless communication system,
said communication terminal comprising:
a direct communication availability inquiring unit configured to transmit a direct communication availability inquiry to the wireless communication system via the first relay device and the access point, the direct communication availability inquiry being an inquiry for searching for a device having a function of performing direct wireless communication that is wireless communication not via the access point; and
a connection state switching unit configured to cause the first relay device to switch communication between the communication destination device and the first relay device, from indirect wireless communication to the direct wireless communication, by transmitting a direct communication start instruction to the first relay device according to receipt of a direct communication availability notification from both the communication destination device and the first relay device in response to the direct communication availability inquiry, the indirect wireless communication being wireless communication via the access point, the direct communication start instruction being an instruction to start the direct wireless communication between the communication destination device and the first relay device, and the direct communication availability notification indicating that the direct wireless communication is available.

15. The communication terminal according to claim 14,
wherein the communication destination device includes: a destination terminal that performs communication with said communication terminal; and a second relay device that is connected via a wired network to the destination terminal and relays data between the destination terminal and the wireless communication system, and
said connection state switching unit is configured to transmit the direct communication start instruction to the first relay device according to receipt of the direct communication availability notification from both the first and second relay devices, the direct communication start instruction being an instruction to start the direct wireless communication between the first relay device and the second relay device.

16. The communication terminal according to claim 15, further comprising a connection mode inquiring unit configured to transmit a connection mode inquiry to each of the first relay device and the second relay device, the connection mode inquiry being an inquiry about information on a terminal connected via a wired network to a corresponding one of the first and second relay devices,
wherein said connection state switching unit is further configured to transmit the direction communication start instruction to the first relay device when it is determined, based on responses of the first and second relay devices to the connection mode inquiry, that said communication terminal and the destination terminal are connected to different relay devices via wired networks, the direct communication start instruction being an instruction to start the direct wireless communication between the first relay device and the second relay device.

17. The communication terminal according to claim 16,
wherein said connection mode inquiring unit is configured to inquire, using the connection mode inquiry, about information on the access point wirelessly connected to the relay device in addition to information on the terminal connected via the wired network, and
said connection state switching unit is further configured to transmit the direct communication start instruction to the first relay device when it is determined, based on the responses of the first and second devices to the connection mode inquiry, that the first relay device and the second relay device are wirelessly connected to the same access point, the direct communication start instruction being an instruction to start the direct wireless communication between the first relay device and the second relay device.

18. The communication terminal according to claim 17,
wherein said communication terminal is connected to the first relay device via a third relay device that is connected to said communication terminal and the first relay device via wired networks and is wirelessly connected to a second access point that is different from the access point,
said connection mode inquiring unit is configured to transmit the connection mode inquiry to each of the first to third relay devices, and
said connection state switching unit is configured to transmit the direct communication start instruction to the first relay device when it is determined, based on responses of the first to third relay devices to the connection mode inquiry, that the third relay device to which said communication terminal is connected directly via the wired network is not wirelessly connected to the same access point as the second relay device, and the first relay device to which said communication terminal is connected indirectly via the wired network is connected to the same access point as the second relay device, the direction communication start instruction being an instruction to start the direction wireless communication between the first relay device and the second relay device.

19. A relay device which relays data between a communication terminal and a wireless communication system in which an access point, a communication destination device, and a communication terminal are connected, the access point relaying data in wireless communication, the communication destination device being wirelessly connected to the access point, and the communication terminal performing wireless communication with the communication destination device,
said relay device comprising:
a wired communication interface connected to the communication terminal via a wired network;
a wireless communication interface having a function of performing indirect wireless communication that is wireless communication via the access point, and direct wireless communication that is wireless communication not via the access point;
a direct communication availability notification transmitting unit configured to transmit a direct communication availability notification to the communication terminal according to receipt of a direct communication availability inquiry from the communication terminal, the direct communication availability notification indicating that the direct wireless communication is available, and the direct communication availability inquiry being an inquiry about whether or not the function of performing the direct wireless communication is provided; and
a connection state switching unit configured to switch communication between said wireless communication interface and the communication destination device, from the indirect wireless communication to the direct wireless communication, according to receipt of a direct communication start instruction from the communication terminal, the direct communication start instruction being an instruction to start the direct wireless communication with the communication destination device.

20. The relay device according to claim 19, further comprising:
a storage unit configured to hold information on a terminal connected to said wired communication interface; and
a connection information notification transmitting unit configured to transmit a connection information notification according to receipt of a connection information inquiry, the connection information notification indicating the information on the terminal, which is held by said storage unit, and the connection information inquiry being an inquiry about the information on the terminal connected to said relay device via the wired network.

21. The relay device according to claim 20,
wherein said storage unit is further configured to hold information on the access point connected to said wireless communication interface, and
said connection information notification transmitting unit is configured to transmit the information on the access point, which is held by said storage unit, in addition to the connection information notification, according to receipt of the connection information inquiry.

22. A wireless communication system in which an access point, first and second communication devices, and a relay device are connected, said access point relaying data in wireless communication, said first and second communication devices being wirelessly connected to said access point and performing wireless communication with each other, and said relay device relaying data between said first and second communication devices,
wherein said first communication device includes:
a first wired communication interface connected to said relay device via a wired network;
a direct communication availability inquiring unit configured to transmit a direct communication availability inquiry to said wireless communication system via said relay device and said access point, the direct communication availability inquiry being an inquiry for searching for a device having the function of performing direct wireless communication that is wireless communication not via said access point; and
a first connection state switching unit configured to cause said relay device to switch communication between said second communication device and said relay device, from indirect wireless communication to the direct wireless communication, by transmitting a direct communication start instruction to said relay device according to receipt of a direct communication availability notification from both said second communication device and said relay device in response to the direct communication availability inquiry, the indirect wireless communication being wireless communication via said access point, the direct communication start instruction being an instruction to start the direct wireless communication between said second communication device and said relay device, and the direct communication availability notification indicating that the direct wireless communication is available,
said relay device includes:
a second wired communication interface connected to said first communication device via a wired network;
a first wireless communication interface having a function of performing the indirect wireless communication and the direct wireless communication;
a first direct communication availability transmitting unit configured to transmit the direct communication availability notification to said first communication device according to receipt of the direct communication availability inquiry from said first communication device; and
a connection state switching unit configured to switch communication between said first wireless communication interface and said second communication device, from the indirect wireless communication to the direct wireless communication, according to receipt of the direct communication start instruction from said first communication device, and
said second communication device includes:
a second wireless communication interface having a function of performing the indirect wireless communication and the direct wireless communication;
a second direct communication availability transmitting unit configured to transmit the direct communication availability notification to said first communication device according to receipt of the direct communication availability inquiry from said first communication device; and
a second connection state switching unit configured to switch communication between said second wireless communication interface and said relay device, from the indirect wireless communication to the direct wireless communication, according to transmission of the direct communication availability notification to said first communication device.

23. A method of controlling wireless communication by switching communication between first and second communication devices, from indirect wireless communication that is wireless communication via an access point, to direct wireless communication that is wireless communication not via the access point, in a wireless communication system which connects the access point for relaying data in the wireless communication, and the first and second communication devices that perform the wireless communication with each other, wherein the first communication device is connected, via a wired network, to a relay device that relays data between the first communication device and the wireless communication system so that the first communication device is connected indirectly to the wireless communication system,
said method comprising:
transmitting a direct communication availability inquiry from the first communication device to the wireless communication system via the relay device and the access point, the direct communication availability inquiry being an inquiry for searching for a device having a function of performing the direct wireless communication;
transmitting a direct communication availability notification from both the second communication device and the relay device to the first communication device according to receipt of the direct communication availability inquiry from the first communication device, the direct communication availability notification indicating that the direct wireless communication is available; and
switching communication between the relay device and the second communication device, from the indirect wireless communication to the direct wireless communication, by transmitting a direct communication start instruction from the first communication device to the relay device according to receipt of the direct communication availability notification from both the second communication device and the relay device, the direct communication start instruction being an instruction to start the direct wireless communication between the second communication device and the relay device.

24. A non-transitory computer-readable recording medium storing a program causing a communication terminal to perform wireless communication with a communication destination device, the communication terminal being connected to a wireless communication system which connects an access point for relaying data in wireless communication, wherein the communication terminal is connected, via a wired network, to a relay device that relays data between the communication terminal and the wireless communication system so that the communication terminal is connected indirectly to the wireless communication system,
the program causing the communication terminal to execute:
transmitting a direct communication availability inquiry to the wireless communication system via the relay device and the access point, the direct communication availability inquiry being an inquiry for searching for a device having a function of performing direct wireless communication that is wireless communication not via the access point; and
switching communication with the communication destination device, from indirect wireless communication to the direct wireless communication, by transmitting a direct communication start instruction to the relay device according to receipt of a direct communication availability notification from both the communication destination device and the relay device in response to the direct communication availability inquiry, the indirect wireless communication being wireless communication via the access point, the direct communication start instruction being an instruction to start the direct wireless communication between the communication destination device and the relay device, and the direct communication availability notification indicating that the direct wireless communication is available.
